(19) United States
(12) Patent Application Publication
(10) Pub. No.: US 2016/0324363 A1
(43) Pub. Date: Nov. 10, 2016

(54) Novel Device for Maximizing the Production of and Preservation of 2-furfurylthiol in Frozen Coffee Cubes

(71) Applicant: Ross Cohen, Jericho, NY (US)

(72) Inventor: Ross Cohen, Jericho, NY (US)

(73) Assignee: Ross Cohen, Jericho, NY (US)

(21) Appl. No.: 14/601,262

(22) Filed: Jan. 21, 2015

(51) Int. Cl. A47J 31/42; A23F 5/30; A47J 31/00

(52) U.S. Cl. CPC A47J 31/42; A47J 31/002; A23F 5/30

(57) ABSTRACT

The invention is comprised of a rotating glass coffee bean gas flame torrefaction drum which roasts and rapidly grinds fresh coffee beans. This feeds a brewing device designed to accelerate making solid ice as quickly as possible in order to arrest the hydrolysis kinetics of 2-furfuryrlthiol. The heat exchanger portion has exceptionally high surface area heat exchanger coils.

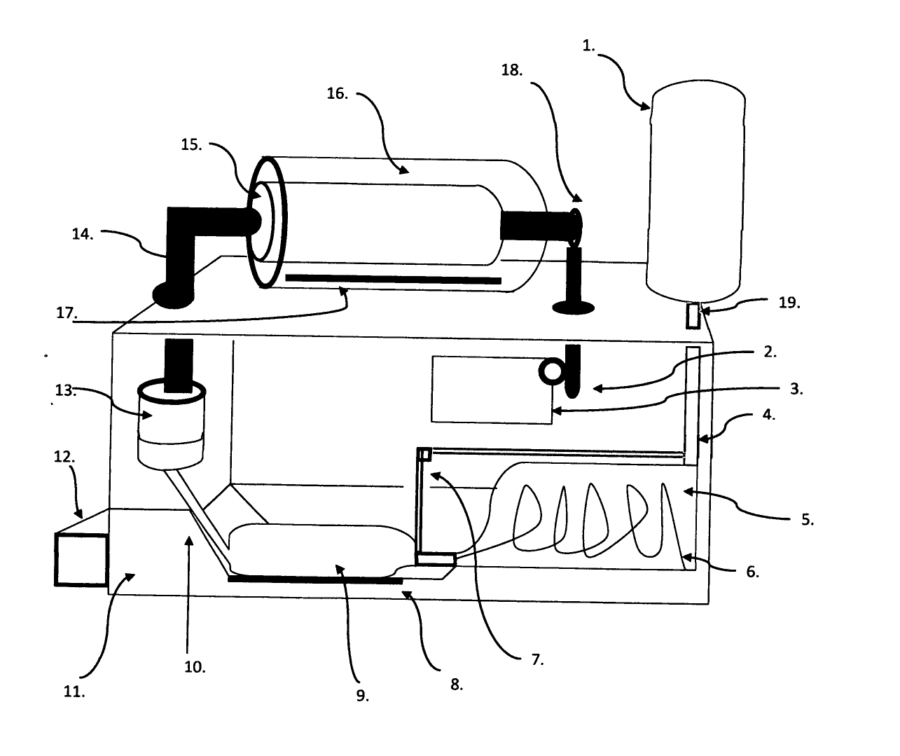

Higher mass exchange of the device prevent specific chemical component flavor loss. In addition, the torrefaction process in the glass drum attached to the device with rapid grinding process allows for much higher levels of 2-furfurylthiol in ice cubes. The glass allows visualization of the flame.

The consumer enjoys of the product visually and by smell prior to product consumption.

### FIELD OF THE INVENTION

The invention is related to food ingredient chemical processing.

### BACKGROUND OF THE INVENTION

Coffee has been in the public domain records since the 16th century, when it became the object of international trade, to before description of coffee in Ethiopian legends centuries before.

As the use of coffee has persisted to the present, two trends which are the objects of this invention, increased. The first is the consumption of chilled coffee beverages, and the second is the search for a higher quality product.

The quality of the product is determined, in part by the sour and bitterness taste bud receptors in the mouth, but mostly by olfactif receptors found in the sinuses. This comes from the release of volatile flavor compounds at the back of the mouth into the sinuses.

The dilemma is making the best coffee product is that the most important flavor molecule is chemically degraded usually within the first 10 minutes. This molecule in coffee accounts for the aroma of freshly brewed coffee, 2-furfurylthiol. As it turns out, this degradation process has made the manufacturing of fresh tasting coffee products in powder or liquid concentrate form by the industrial food industry almost impossible. While the coffee bean roasting process is usually separated temporally and specially speaking, additional flavor loss occurs between roasting and grinding. In addition, since coffee bean roasting does increase certain flavors by reducing bitterness and increasing caramels, the complexity of the soluble compounds is well described, however the aroma release during roasting is considerable since many smaller molecules volatilize during the process. This can be considered to be lost flavor which only benefits those close to the pleasant smell produced during the roasting process. So if flavor preservation based upon chemical degradation of the specific chemical species present in coffee and derived products is considered as the invention, the prior art is separated into chemical research, chemical solutions such as antioxidants, buffers, and chemical stabilizers, and devices which produce coffee flavored ice cubes where the coffee is the end product, and not a chemically defined coffee chemical constituents in the final product. This represents a critical gap in the prior art and the current invention.

In application 20120192584, Fliaschi describes a coffee brewing machine which creates ice cubes from an internal brewing device. The aim is to produce a coffee flavored ice cube to prevent the dilution of the coffee flavor in iced coffee by dilution from melting ice, but not an ice cube which increases the flavor above normal ranges associated with brewing. In issued U.S. Pat. No. 8,635,944 Buchholz, et al. describe a process by which fresh coffee is mixed with coffee concentrate and water to achieve a product, but does not claim it's conversion to an ice cube. In U.S. Pat. No. 8,459,043 Bertone et al. describe a coffee beverage that has coffee concentrate added to make a cold slush beverage. In U.S. Pat. No. 4,882,983 the author Pastrick describes a device for measuring out the liquid and brewing hot beverages in an automated device. In U.S. Pat. No. 8,794,127 Nosler, et al. describe a piston based system which tries to obtain variable coffee product dispensing process, which has consistency for each variety produced.

None of the prior art cited relates to specific timing of events and processes in order to produce a chemically modified product. There is prior art in using purely chemical and biochemical means to preserve coffee flavor components.

In US application 20100015276, SilanesKenny; Francisco Javier; et al. describe a biochemical system for stabilizing 2-furfurylthiol using an enzymatic process.

In US applications 20110274816, 20100330241,20080038421 the authors Gretsch; Catherine; et al. describe a ceramic matrix to preserve coffee flavor by barrier and adhesion.

### OBJECTS OF THE INVENTION

One object of the invention is to create a more effective process for capturing volatile aromatic compounds from coffee. Yet another object of the invention is to incorporate visualizing fresh coffee bean roasting into the grinding and brewing of the precursor to coffee flavored ice cubes. Yet another object of the invention is to produce coffee ice cubes with optimal aroma and flavor profiles. Yet another object of the invention is to specifically reduce the loss of 2-furfurylthiol by shortening the time from bean roasting, and subsequent grinding, and extraction, and freezing to 5 minutes or less. Yet another object of the invention is to quickly freeze and capture other plant beverage aromas in order to maximize beverage flavor.

### SUMMARY OF THE INVENTION

The device has horizontal a glass rotating cylinder in which unroasted coffee beans or herbs are exposed to a gas flame. Once the material is sufficiently roasted, the glass cylinder tilts upwards and the contents are emptied into a grinding process inside the device and powdered. The powder is then directly brewed and extracted using pressurized extraction and the resulting liquid is run through small diameter metal heat exchanger coil system with rapid cooling. The resulting cooled liquid is flash-frozen into low-flavor-loss iced cubes within 5 to 10 minutes of the beans being roasted, or herbal ingredients being brewed.

### DETAILED DESCRIPTION OF THE INVENTION

The invention has four operations built into one device. All of the processes are combined temporally in a combination for the specific extraction preservation and storage in ice of a coffee extract which does not loose 2-furfurylthiol through chemical decomposition and evaporation. This means that process times and heat loss have to be precisely timed for the maximum harvest of this compound through two stages.

In the first stage the volatiles are released from the glass torrefaction cylinder with a natural gas flame. The beans freshly roasted are now emptied by the cylinder into the just-in-time grinding process. The beans pass through a hollow conveyor tube that acts as a conduit and as an axel component for the rotating cylinder. The cylinder is inclined when the beans are ready and are fed into the grinder by gravity or with a mechanical screw feed.

Once the beans are ground to 0.2 millimeters or less, the powder is fed into a pressurized stainless steel extractor and compressed into a plug. The plug is then filled with pressurized hot water for 4 minutes. The brewed coffee is then fed through a narrow stainless steel or copper heat exchanger coil, which can have additional metallic outer baffles, in order to optimize heat exchange. The cooled coffee is introduced into the ice tray at 1 to 2 degrees Celsius and chilled into ice cubes.

The ice cubes then can be served with drinks releasing 2-furfurylthiol at near original rates with the brewed product from the liquid extraction process.

1) A device which incorporates coffee bean roasting, grinding and brewing and conversion to ice cubes within 5 to 7 minutes in order to optimize the extraction and retention of 2 furfurylthiol in a final coffee ice cube.

2) The claim in 1 where the device can be used to release volatile flavors in herbs and teas by drying fresh plant matter into powder.

3) A device which incorporates coffee bean roasting, grinding and brewing and conversion to ice cubes within 5 to 7 minutes in order to optimize the extraction and retention of 2 furfurylthiol in the final coffee ice cube, with all processing visualized through a transparent panel which shows the different parts.

4) The claim in 1 where the bean roaster is made of borosilicate glass and is evacuated by a gravity feed into the grinder.

5) The claim in 3 where the bean roaster is made of borosilicate glass and is evacuated by a gravity feed into the grinder.

6) The claim in 1 where all the heat for the coffee bean or fresh herb roasting, as well as brewing extraction, is supplied by natural gas flame.

7) The claim in 1 where the facing material allowing visualization is polycarbonate.

8) The claim in 3 where the facing material allowing visualization is polycarbonate.
